(19) United States
(12) Patent Application Publication
(10) Pub. No.: US 2007/0040395 A1
(43) Pub. Date: Feb. 22, 2007

(54) Padlock seal

(76) Inventor: Youn-Sil Lee, Kunpo-Si (KR)

Correspondence Address: ABELMAN, FRAYNE & SCHWAB, 666 THIRD AVENUE, 10TH FLOOR, NEW YORK, NY, 10017, US

(21) Appl. No.: 11/295,124

(22) Filed: Dec. 5, 2005

(30) Foreign Application Priority Data
Aug. 17, 2005 (KR) 05/23390

(51) Int. Cl. G09F 3/03; B65D 55/06

(52) U.S. Cl. 292/320

(57) ABSTRACT

A padlock seal includes a main body including a first and second cavity. The first and second cavities are separated by a divider member that defines a wall in the first and second cavities. The divider member includes at least one catch formed on each wall of the cavities, and each of the at least one catches in each cavity is formed perpendicular with respect to the first and second cavities. A locking wire includes a pressing member and a pair of coupling members coupled to opposing ends of the pressing member. The coupling members each have a flexible hook portion for interfacing with said at least one catch in a corresponding cavity of the main body.

### FIELD OF INVENTION

This invention relates generally to tamper-indicating or tamper-evident devices, and more particularly to a padlock seal device for use with security boxes, personal luggage and baggage used by travelers, food carts for airlines and cruise ships, and other shipping and storage containers for goods that are subject to unauthorized opening and/or tampering.

### BACKGROUND OF THE INVENTION

It is known in the art in the case of commercial containers to provide a “wire seal” that is threaded through a lock hasp or similar closure. The free ends of the length of wire are then clamped with a malleable metal seal in such manner that the container may be opened only by cutting the wire or damaging the seal thereby providing immediate notice to a consignee that the container has been tampered with, even if a principal closure remains in place. Such devices require a tool to cut the seal, and are not entirely free of the possibility of concealing the temporary opening of the seal portion.

There are other sealing devices that have been employed by commercial airlines and cruise ships, as well as travelers, that do not require special tools for cutting the seals. The containers, such as luggage, security boxes and containers of goods, and food carts are sealed by various devices to keep their contents therein safe and secure, and to discourage theft.

Referring to FIG. 1, a prior art padlock seal 1 is shown. The padlock seal includes a body 2 and a locking wire 6. The body 2 is generally rectangular in shape and includes a pair of coupling cavities 3 and 3′ (collectively coupling cavities 3) in an upper surface of the body 2. The locking wire 6 is generally formed as a loop having opposing coupling members 10 and 10′, where each end is aligned for insertion into a respective cavity 3 and 3′.

The locking wire 6 includes a horizontal pressing member 7, a pair of opposing outwardly angled extension members 8 and 8′, a pair of opposing inwardly angled members 9 and 9′, and the pair of opposing coupling members 10 and 10′. The horizontal member 7 is positioned horizontally over the upper surface to form an opening and to facilitate entry of the wire 6′ into the cavities 3 and 3′. At opposing ends of the horizontal member 7 are formed an angled extension member 8 and 8′, followed by inwardly angled or sloping member 9 and 9′, which are formed at each end of the extension members 8 and 8′, respectively. The coupling members 10 and 10′ are formed at each end of the inward sloping members 9 and 9′, respectively. The coupling members 10 and 10′ are curved inwardly at each end towards each other.

Notches or weakened areas 11 and 11′ are formed in the inward sloping member 9 and 9′, respectively. The cutouts 11 are provided to allow an end user to break off the locking wire 6 from the body 2 at the cutouts 11 by bending the horizontal member 7 and extension members 8 and 8′ back and forth at the cutouts 11 and 11′ until separation.

FIG. 2 shows the locking wire 6 in a locked position within the body 2, as well as an unlocked position, which is drawn in phantom. The coupling members 10 and 10′ are inserted into the cavities 3 and 3′, respectively, to lock the padlock seal 1.

The cavities 3 and 3′ are separated within the body 2 by a divider member 12. The divider member 12 has opposing sides that form a wall in each cavity 3 and 3′. Thus, each cavity is formed by the interior walls of the body 2 and an opposing side of the divider member 12.

The cavities 3 and 3′ include a plurality of engagement surfaces or offsets 4 and 5 (hereinafter referred to as “catches”). The cavity 3 includes a first engagement surface (i.e., “catch”) 4a and a catch 5a formed on the divider member 12 in cavity 3. Similarly, the cavity 3′ includes a first engagement surface 4b and a second engagement surface 5b formed on the opposing side of the divider member 12 in cavity 3′. The first catches 4a and 4b are formed proximate the upper surface of the body 2, while the second catches 5a and 5b are formed in the cavities 3 and 3′ below the first catches.

The divider member 12 includes three sections, where the first section is positioned between the cavities 3 and 3′ proximate the top of the body 2 and has a width greater than the width of the second section of the divider member, which is below the first section proximate the middle of the body 2. Further, the third section of the divider member 12 is below the second section proximate the bottom of the body 2 and has a width that is less than second section of the divider member 12. Thus, the divider member 12 forms a declining staircase structure on each opposing wall in the cavities 3 and 3′.

The first and second catches are formed at the transitions between each section of the divider member. For example, the first catches 4a and 4b are formed at the transition between the first and second sections, while the second catches 5a and 5b are formed at the transition between the second and third sections of the divider member 12. Each catch (i.e., transition) is sloped inward and downward towards the bottom of the cavities 3, as opposed to being formed perpendicular to the upper and bottom surfaces of the body 2.

In this prior art padlock seal 1, the sealing operation is achieved by insertion of the locking wire 6 into the body 2. Specifically, the coupling members 10 and 10′ are pushed into the cavities 3 and 3′, respectively, by pushing down on the horizontal member 7, such that the curved ends of the coupling members 10 are coupled and held by the both the first and second catches.

As shown in FIGS. 1 and 2, the coupling member 10 inserted in the first cavity 3 has a length which is longer than the coupling member 10′ that is inserted in the second cavity 3′. The coupling extension member 10 that is inserted into the first cavity 3 abuts against and “catches” the second catch 5a and is retained there against by frictional forces. The coupling member 10′ inserted in the second cavity 3′ abuts against and catches the first catch 4b and is retained there against in a similar manner.

It was observed that during use of these prior art padlock seals 1, the locking wire 6 would not securely lock against or engage the first and second catches. Rather, the sloped surfaces of the catches do not provide sufficient frictional forces, which could be overcome by pulling the locking wire 6 away from the body 2. That is, the coupling members 10 of the locking wire 6 that engage the catches 5a and 4b are not securely supported at the transitions, such that the locking wire 6 could be detached from main body 2 when the main body 2 was forcibly pulled from the locking wire 6. Accordingly, the seals of security boxes and: goods containers could be easily manipulated or pilfered by unauthorized personnel.

When the seal is properly opened by authorized persons, the bottom part of the locking wire 6 is pressed by force by grasping the main body 2 to the extent that the locking wire 6 is bent. The force is applied until the notched portions 11 and 11′ that are formed identically at the inward sloping members 9 and 9′ of the locking wire 6 are broken and separated from the main body 2.

However, when the seal 1 is uncoupled while preparing to open a food cart, such as an airline or cruise ship food cart, it has been observed that the separated portion of the locking wire 6 has frequently dropped into the food cart, and could possibly contaminate the food or pose other safety issues.

### SUMMARY OF THE INVENTION

The disadvantages heretofore associated with the prior art are overcome by the present invention of a padlock seal structure that provides a tamper resistant seal. The structure of the device to achieve this purpose includes a main body, illustratively, in the shape of a rectangular parallelepiped having a divider member, which has coupling holes (cavities) formed at both sides of the divider member, and optionally, and indexing portion formed on an outer surface for receiving identification information; a sealing structure that includes a locking wire having a top pressing member, an extension member extending substantially perpendicular at opposing ends of the pressing member, an inward member extending inwardly at a bottom of each extension part, and a coupling member extending with a downward inclination from the end of each inward member. The coupling members are inserted into a respective coupling cavity of the main body. First and second catches are formed internally in the main body in a staircase structure perpendicular to the cavities. The locking wire is inserted into the main body by applying a force on the pressing member towards the main body until the coupling members come into contact with the catches in the main body.

The padlock seal is opened by breaking a single notch or cutout formed in the locking wire. In one embodiment, the single notch is formed between one of the inward members and associated coupling member of the locking wire.

The coupling members of the locking wire are rigidly supported by both the first and second catches because the catches are formed perpendicular to the coupling cavity of main body. Therefore, the locking wire can not be easily removed from the main body.

### BRIEF DESCRIPTIONS OF THE DRAWINGS

The teachings of the present invention can be readily understood by considering the following detailed description in conjunction with the accompanying drawings, in which:

FIG 1 is a side perspective view of a prior art padlock seal;

FIG. 2 is a cross-sectional view along section line 2-2 of the prior art padlock seal of FIG. 1 in an opened and unsealed configuration;

FIG. 3 is a cross-sectional view of the prior art padlock seal of FIG. 2 in a closed and sealed configuration;

FIG. 4 is a side perspective view of a padlock seal of the present invention;

FIG. 5 is a cross-sectional view of the padlock seal along section line 5-5 of FIG. 4 in an opened and unsealed configuration;

FIG. 6 is a cross-sectional view of the padlock seal of FIG. 5 in a closed and sealed configuration; and

FIG. 7 is a cross-sectional view of the padlock seal of FIG. 5 in a closed and unsealed configuration.

To facilitate understanding, the same reference numerals have been used, when appropriate, to designate the same or similar elements that are common to the figures.

### DETAILED DESCRIPTION OF THE INVENTION

The characteristics and benefits of this device will be clear by the following explanation with reference to the drawings attached here. The padlock seal of the present invention includes a novel structure as described below, which can be used for sealing security boxes, containers for goods, among other items, as well as for sealing carts in which goods and food are stored for sale, illustratively during travel in an aircraft or cruise ship and the like.

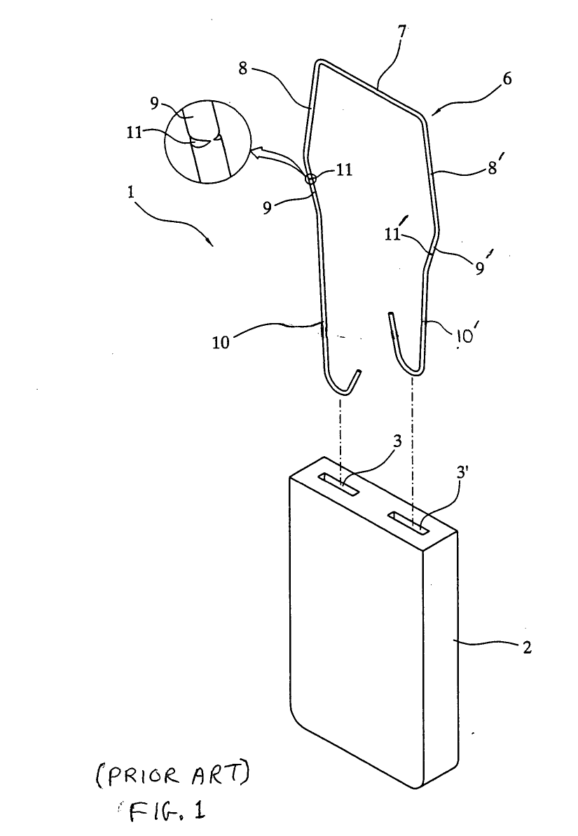

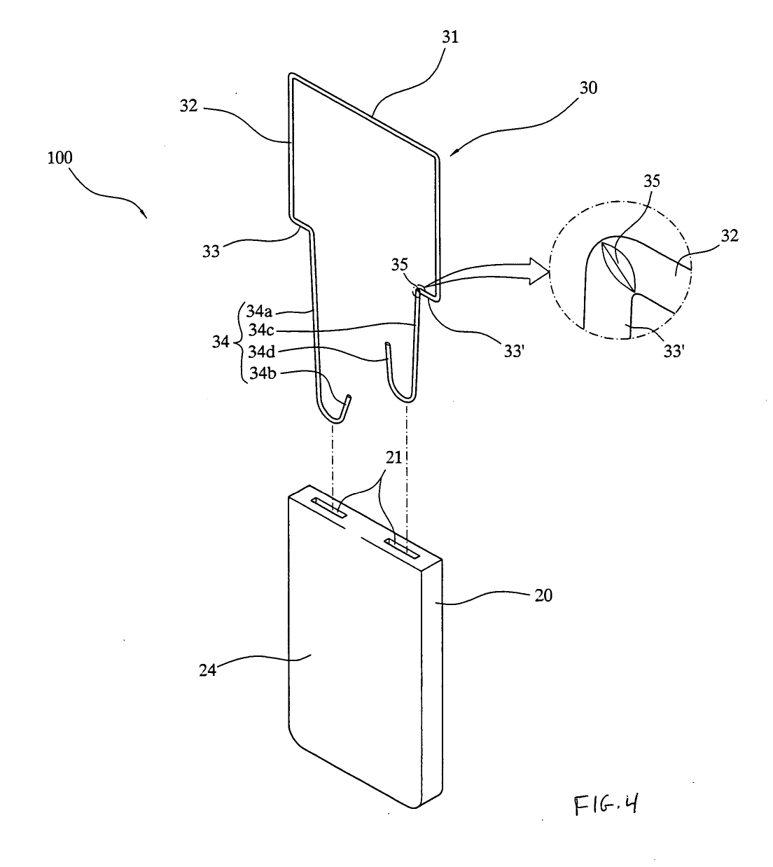

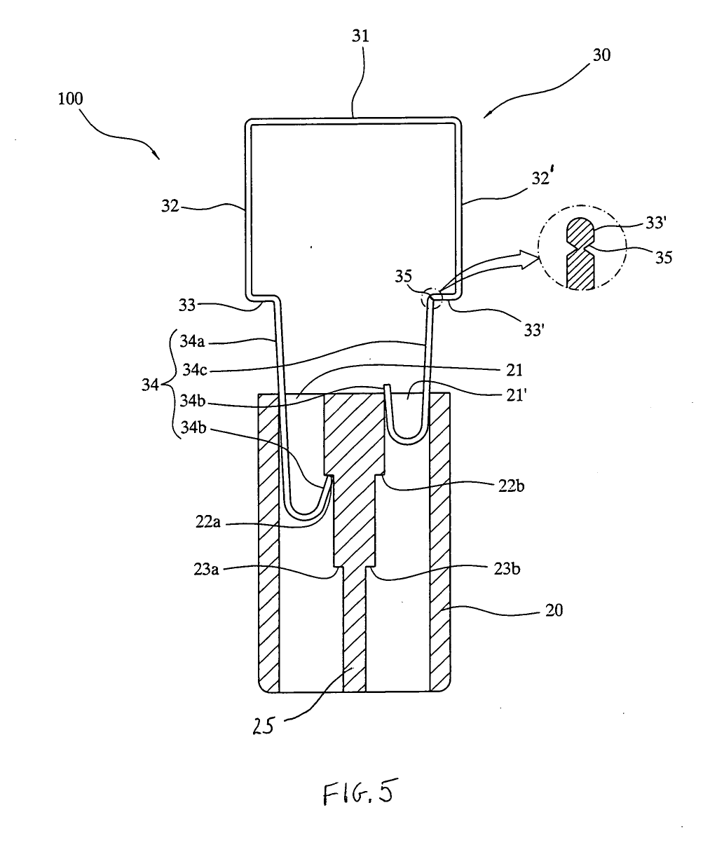

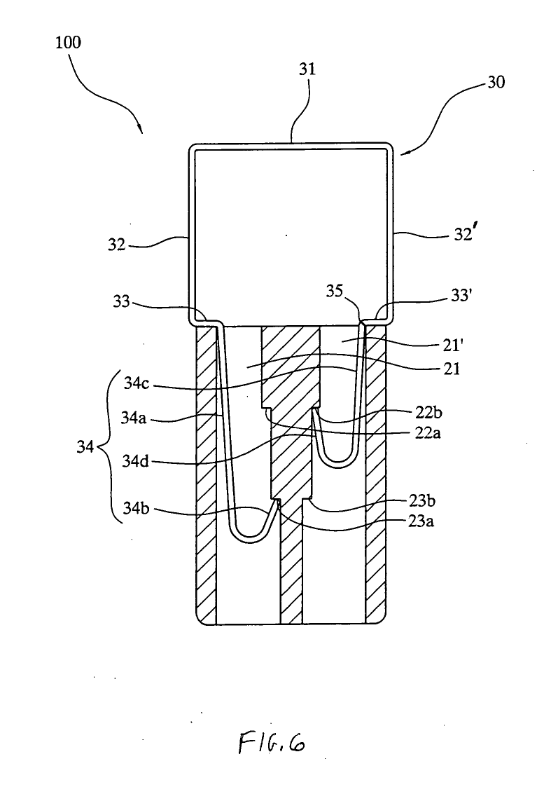

FIG. 4 is a side perspective view of a padlock seal 100 of the present invention, and FIG. 5 is a cross-sectional view of the padlock seal of FIG. 4 in an opened and unsealed configuration, which collectively illustrate the structure of the padlock seal. FIG. 6 is a cross-sectional view of the padlock seal 100 of FIG. 1 in a closed and sealed configuration.

Referring to FIG. 4, the padlock seal 100 comprises a main body 20 and locking wire 30. The main body 20 includes an index 24 on an outer surface of the main body 20 (e.g., a side surface) to accommodate the printing or engraving of a serial number or other information thereon. The main body 20 further includes a pair of coupling cavities 21 and 21′ (collectively cavities 21). The cavities 21 and 21′ are separated by a divider member 25 that extends substantially vertical from the top of the main body to the bottom of the main body 20. The divider member 25 has opposing sides that form a wall in each cavity 21 and 21′. Thus, each cavity is formed by the interior walls of the body 20 and an opposing side of the divider member 25, and is sized to receive the opposing ends of the locking wire 30.

Referring to FIG. 5, the divider member 25 includes a plurality of engagement surfaces or offsets 22 and 23, hereinafter referred to as “catches.” In particular, cavity 21 includes a first catch 22a and a second catch 23a formed on the divider member 25 in cavity 21. Similarly, the cavity 21′ includes a first catch 22b and a second catch 23b formed on the opposing side of the divider member 25 in cavity 21′. The first catches 22a and 22b (collectively first catches 22) are formed proximate the upper surface of the body 20, while the second catches 23a and 23b (collectively second catches 23) are formed in the cavities 21 and 21 ′ below the first catches.

The divider member 25 includes three sections, where the first section is positioned between the cavities 21 and 21′ proximate the top of the body 20 and has a width greater than the width of the second section of the divider member, which is below the first section proximate the middle of the body 20. Further, the third section of the divider member 25 is formed below the second section proximate the bottom of the body 20 and has a width that is less than second section of the divider member 25. Thus, the divider member 25 forms a declining staircase structure on each opposing wall in the cavities 21 and 21′.

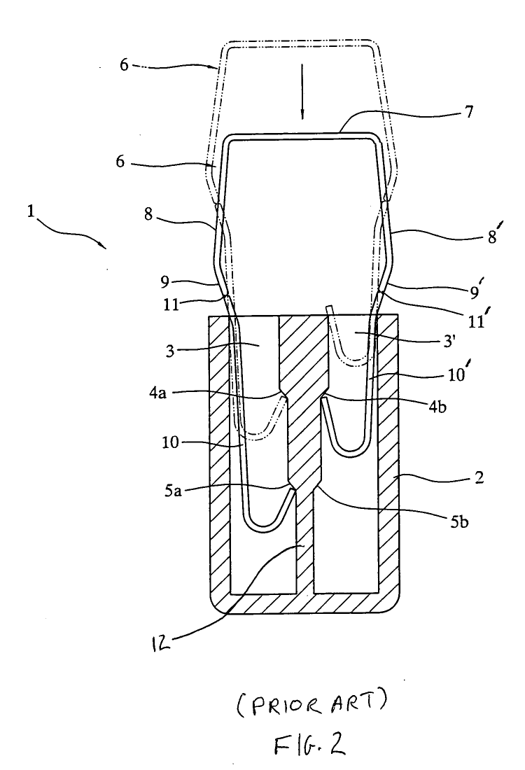

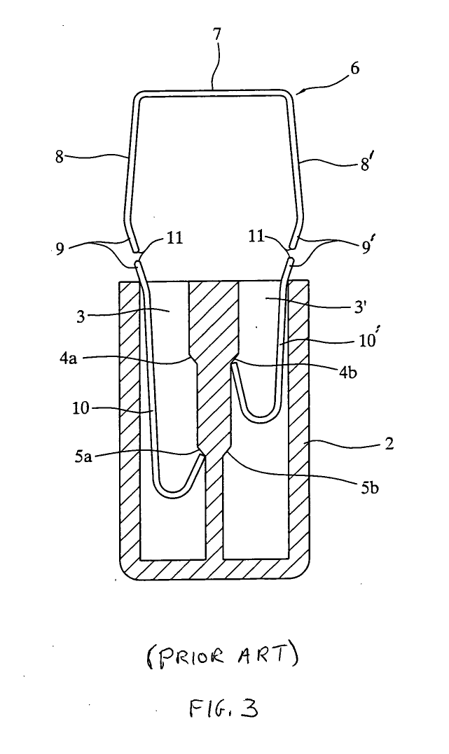

The first and second catches are formed at the transitions between each section of the divider member 25. For example, the first catches 22a and 22b are formed at the transition between the first and second sections, while the second catches 23a and 23b are formed at the transition between the second and third sections of the divider member 12. Each catch′ (i.e., transition) is formed perpendicular to the upper and bottom surfaces of the body 20, as opposed to being sloped inward and downward towards the bottom of the cavities as shown in prior art padlocks of FIGS. 1-3.

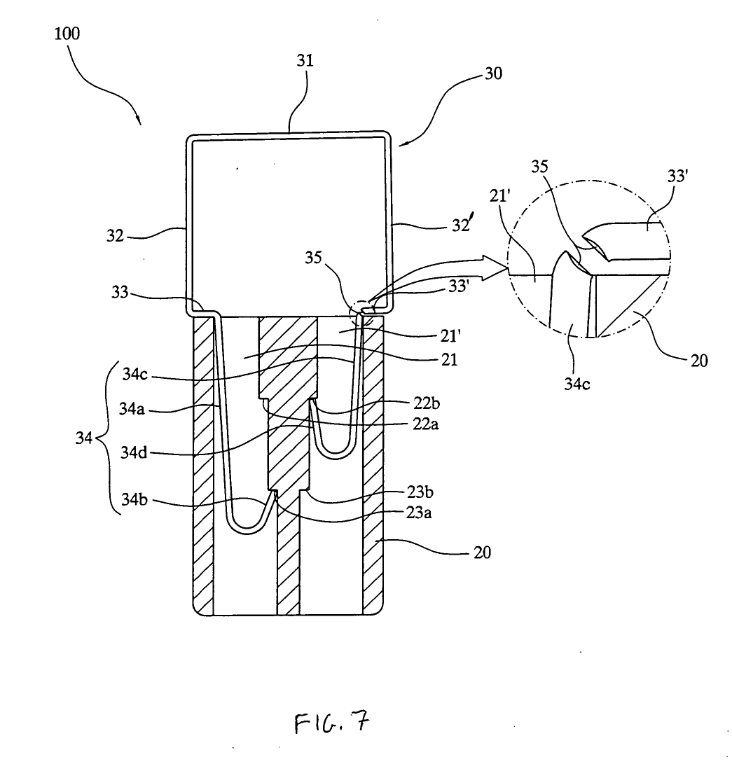

The locking wire 30 includes a pressing member 31, a pair of opposing extension members 32 and 32′, a pair of opposing inward members 33 and 33′, and a pair of opposing coupling members 34 and 34′. The pressing member 31 is positioned substantially horizontally over the upper surface of the body 20 that facilitates the openings of the cavities 21 and 21′. At opposing ends of the horizontal pressing member 31 are formed substantially vertical extension member 32 and 32′, followed by the inward members 33 and 33′, which are substantially parallel with respect to the horizontal member 31. The inward members 33 and 33′ prevent the locking wire 30 from being inserted to far into the cavities of the main body 20 when the locking wire 30 is pressed downward, as illustratively shown in FIG. 7. In particular, the inward members 33 and 33′ will abut against the upper surface of the body 20 to prevent a user from attempting to insert the locking wire 30 into the main body 20 below its operable locking position.

The coupling members 34a and 34c are formed at each end of the inward members 33 and 33′, respectively. The coupling members 34a and 34c include hook portions 34b and 34d at their respective ends that curve inward towards each other.

The coupling members 34 are sized differently in length, such that a shorter one of the coupling members will be retained against a first catch, while a longer one of the coupling members will be retained against a second catch when the locking wire 30 is inserted into the body 20. For example, as shown in FIG. 6, coupling member 34a is longer than coupling member 34c, and inward curved hook portion 34b is secured by second catch 23a, while inward curved hook portion 34d is secured by first catch 22b when the locking wire 30 is inserted into the cavities 21 and 21′ of the body 20.

Referring to FIG. 4, another distinguishing characteristic of the padlock seal of the present invention is that a notch or weakened portion 35 is formed on only one of the pair of inward members 33 or 33′. In a preferred embodiment, the single notch 35 is formed at the bend or corner interface between an inward member 33 and its associated coupling member 34. For example, as shown in the exploded view of FIG. 4, the notch 35 is formed at the corner between the inward member 33′ and its associated coupling member 34c. One skilled in the art will appreciate that the single notch 35 can be formed along other positions of the locking wire 30 that extend above the coupling members 34 (i.e., above the top surface of the main body 20). The notch 25 is provided to allow an end user to break off the locking wire 30 from the main body 20 at the cutout 25 by bending and twisting the horizontal member 31 and extension members 32 and 32′ back and forth at the cutout 25 until separation occurs.

The locking wire 30 is made of a flexible material (e.g., metal or plastic), such that as each coupling member 34 is inserted into a corresponding cavity 21 of the main body 20, the hook portions of the coupling members 34 are able to engage at the transitions forming the first and second catches 22 and 23. As shown in FIGS. 6 and 7, the first coupling hook portion 34b of the first coupling member 34a is longer than the second coupling hook portion 34d of the second coupling member 34c. Accordingly, when the padlock is a locked state, the first coupling hook 34b engages (“catches”) and interface with the second catch 23a in the first cavity 21, and the second coupling hook 34d engages and interfaces with the first catch 22b in the second cavity 21′.

When sealing a container or food cart is sealed with the padlock seal, the sealing operation is initially performed by uncoupling the second coupling member 34c of locking wire 30 from coupling cavity 21 to thereby open the padlock seal 100. The padlock seal 100 is attached to a container, food cart, or other item to be sealed with the padlock seal, by inserting the second coupling member 34c, illustratively, through an orifice formed in the container or food cart, which is used to receive a locking device, as conventionally known in the art.

Once the second coupling member 34c is inserted through, for example, the orifice associated with the container, the second coupling member 34c is aligned over the cavity 21′, and the locking wire 31 is inserted into the cavities 21 and 21′ of the main body 20 by applying a force (pressing down) on the substantially horizontal member 31 of the locking wire 30 towards the main body 20.

As the downward force is exerted on the horizontal member 31 towards the main body 20, the first longer coupling member 34a slides into the first cavity 21, while the second shorter coupling member 34c slides into the second cavity 21′. The hook portion 34b of the first coupling member 34a slides downward towards the bottom of the main body 20 past the first catch 22a and subsequently engages (“catches”) the second catch 23a in the first cavity 21. That is, end of the hook portion 34b flexes outward towards the divider member 25 as it is inserted into down the cavity 21. Once the end of the coupling hook portion 34b passes the second catch 23a, it flexes outward and engages (i.e., interfaces and locks) with the perpendicular transition (second catch 23a) between the second and third sections of the divider member 25.

Concurrent with the insertion of the first coupling member 34 in to the cavity 21, the second the hook portion 34d of the second coupling member 34c also slides downward towards the bottom of the main body 20 past the first catch 22b in the second cavity 21′. That is, end of the coupling hook portion 34d flexes outward towards associated cavity wall formed by the divider member 25 as it is inserted into the cavity 21 along the upper first section of the divider member 25. Once the end of the coupling hook portion 34d passes the first catch 23b in cavity 21′, the end of the hook portion 34d flexes outward towards the divider member 25 and interfaces (i.e., engages) with the perpendicular transition (second catch 23b) between the first and second sections of the divider member 25.

As the first coupling member 34a and second coupling member 34c are inserted and then supported (locked) by corresponding second catch 23a and first catch 22b of the coupling cavities 21 and 21′, a “clicking sound is generated from the mechanical contact of the hook portions 34b and 34d flexing outward and coming into contact with the perpendicular transitions forming the second and first catches 23a and 22b. That is, since the catches 22 and 23 are formed by right angles to the vertical divider member 25, the spring-like characteristic of the hook portions 34b and 34d spring (expand) outward towards the divider member 25 after passing each section of the divider member 25.

The first coupling member 34a will produce two “clicking” sounds during the locking of the padlock seal 100. A first “clicking” sound can be heard when the coupling hook portion 34b passes the first catch 22a formed between the first and second sections of the divider member 25 in cavity 25. A second “clicking” sound can be heard when the coupling hook portion 34b passes the second catch 23a formed between the second and third sections of the divider member 25 in cavity 21.

Similarly, the second coupling member 34c will click once during the locking of the padlock seal 100. The “clicking” sound can be heard when the hook portion 34d passes the first catch 22b formed between the first and second sections of the divider member 25 in cavity 21′. The clicking sounds enable a user to confirm that the locking wire 30 has been inserted into the main body 20 and that the padlock seal 100 is in a properly locked state.

As discussed above, the inward members 33 and 33′ abut against the upper surface (top) of the main body 20 and prevent the locking wire 30 from being pushed further down into the main body 20. Accordingly, while the inward members 33 and 33′ act as stoppers for the locking wire 30, they also enable the first and second coupling members 34a and 34c to be rigidly supported by each corresponding catch 23a and 22b, as well as prevent tampering by attempting to push the locking wire 30 further down into the body 20 in an attempt to unseat the hook portions 34b and 34d from the catches 23a and 22b, respectively.

The boxes and containers sealed by the locking wire 30 coupled to the main body 20 the padlock seal (100), as described above, are required to be opened by personnel who are authorized to check the contents therein. The seal can be released by cutting or breaking the notch 35 formed between the second coupling member 34c and the inward member 33′, as shown in FIG. 7. The locking wire 30 can be separated at the notch 35 by exerting translational forces at the notch 35, illustratively by grasping the main body 20 and pressing on the extension member 32′ from front and back directions of the padlock seal 100. Alternatively, the notch 35 can be cut with a tool, such as a wire cutter.

When the locking wire 30 is broken at the notch 25, the second coupling member 34c remains inserted in the second cavity 21′, while the first coupling member 34a remains inserted in the first cavity 21, since there is only a single notch 35 formed on the locking wire 30. Therefore, the previously observed problem of food or goods becoming contaminated by a broken locking wire being dropped into it when the sealed padlock is to be released is solved by the present embodiment. In particular, the present embodiment allows the seal to be released while the locking wire 30 is still attached to the main body 20. Accordingly, the padlock seal 100 of the present invention is highly desirable for sealing goods stored in carts (e.g., food carts) and the like associated with travel.

On the other hand, if an unauthorized personnel tries to open the sealed box or container by pulling down the main body 20 by force, the locking wire 30 will not release because the coupling members 34 of locking wire 30 are rigidly supported by the first catches 22a and 22b and the second catches 23a and 23b, which are formed at a right angles with respect to the divider member 25.

Further, even if an unauthorized person tries to manipulate the locking wire 30 by pushing down the coupling members 34 of the locking wire 30 to attempt to open the padlock seal without breaking the seal at the notch 25, the inward members 33 and 33′ prohibit such manipulation because the locking wire 30 can not be pushed further down due to the blocking (“stopper”) function of the inward members 33 and 33′ of the locking wire 30. Further, if an unauthorized person attempts to bend the inward members 33 and 33′ upward in substantial alignment with the extension members 32 and 32′, illustratively with a tool, the notch 35 will break due to the deformation of the inward members 33 and 33′, thereby clearly showing that tampering had occurred on the padlock seal. Therefore, since only an authorized person is permitted to break or cut the notch 35 on the padlock seal (100), it is easy to confirm by looking at the padlock to determine if the box has been opened or not, and accordingly, it enables one to check whether there are any lost contents if any.

By implementing the padlock seal of the present invention, as described above, a user receives numerous advantages. For example, the locking wire 30 can not be easily released, since the coupling members 34 of the locking wire 30 are rigidly supported by the first catch 22b and second catch 23a formed each at right angles to the coupling cavities 21 and 21′ respectively. Further, it is possible to confirm if the padlock seal has been sealed safely just by hearing the “click” sound generated when the coupling members 34 are caught and supported by the first and second catches 22b and 23a, While pressing downward on the pressing member 31 towards the body 20.

Additionally, the potential contamination of food or other goods by the broken locking wire 30 dropping, illustratively, into a food cart during air travel is eliminated. In particular, the locking Wire 30 remains attached to the main body 20 when the locking wire 30 is separated from the body 20 at the notch 35.

Accordingly, unless an authorized person has opened the padlock seal, a padlock seal having a locking wire separated at the notch or anywhere else along the locking wire clearly indicates that there was unauthorized manipulation of the padlock seal, and alerts an owner or authorized personnel to alert security personnel and check for lost contents.

While the disclosed structure and apparatus have been particularly shown and described with respect to the preferred embodiments, it will be apparent to those of ordinary skill in the art that various modifications in form and detail can be made without departing from the scope and spirit of the invention. Accordingly, modifications such as those suggested above, but not limited thereto are to be considered within the scope of the invention, which is to be determined by reference to the appended claims.

What is claimed is:

1. A padlock seal, comprising:
A main body having a central axis at which a rectangular parallelepiped is formed and one surface of which is used as an indexing part; the main body 20 in which a first catch (22a)(22b) and a second catch (23a)(23b) is formed in a shape of staircase arranged at a right angle in the inner part of the coupling cavity (21)(21′) in such the structure of padlock seal that consists of the locking wire the parts of which is to be divided into the horizontal pushing part, the extension parts that are perpendicularly extended from both the end of the pushing part, the bended parts that are extended from the bottom parts of the extension parts and bent, and where forms the coupling parts that are extended downward in inclination from the bended parts and that are coupled to the main body; the padlock seal structure that has such a distinctive characteristic that it consists of the locking wire (30) that the bended parts (33)(33′) are bent each at a right angle to be formed horizontally and that the bended parts (33)(33′) is stuck fast to top of the main body (20) when they are pressed.

2. In relation to claim 1, the distinctively characterized padlock seal structure in which the notched part (35) is provided at only one side of the pair of Bended Parts (33)(33′).

3. A padlock seal, comprising:
a main body including a first and second cavity, said first and second cavities being separated by a divider member, said divider member defining a wall of said first and second cavities and including at least one catch formed on each wall of said cavities, each of said at least one catch in each cavity being formed perpendicular to said first and second cavities;
a locking wire including a pressing member and a pair of coupling members coupled to opposing ends of said pressing member; said coupling members each having a flexible hook portion for interfacing with said at least one catch in a corresponding cavity of said main body.

4. The padlock seal of claim 3, wherein said at least one catch in each cavity comprises a first catch and a second catch.

5. The padlock seal of claim 3, wherein a first of said pair of coupling members has a length greater than a length of a second of said pair of coupling members.

6. The padlock seal of claim 3, wherein said locking Wire further comprises:
an extension member coupled to each opposing end of the pressing member;
an inward member connected between each extension member and a corresponding coupling member, wherein the inward members are extend inward towards each other and parallel to an upper surface of said main body.

7. The padlock seal of claim 3, further comprising a notch formed proximate one of said coupling members.
